(19) United States
(12) Patent Application Publication
(10) Pub. No.: US 2025/0077617 A1
(43) Pub. Date: Mar. 6, 2025

(54) INFORMATION PROCESSING APPARATUS AND MEMORY SYSTEM

(71) Applicant: Kioxia Corporation, Tokyo (JP)

(72) Inventor: Atsushi KAWASUMI, Fujisawa (JP)

(73) Assignee: Kioxia Corporation, Tokyo (JP)

(21) Appl. No.: 18/822,608

(22) Filed: Sep. 3, 2024

(30) Foreign Application Priority Data
Sep. 6, 2023 (JP) 2023-144728

(51) Int. Cl. G06F 17/16

(52) U.S. Cl. CPC G06F 17/16

(57) ABSTRACT

An information processing apparatus includes a first positive wiring line carrying a current of a multiplication value of a first integer element and a second integer element when the multiplication value is zero or more, a first negative wiring line carrying a current of the multiplication value when the multiplication value is zero or less, a second positive wiring line activated when the second integer element is positive, a second negative wiring line activated when the second integer element is negative, a first calculator carrying the current through the first positive wiring line when the multiplication value is zero or more, a second calculator carrying the current through the first negative wiring line, a third calculator caused the current to flow through the first positive wiring line when the multiplication value is zero or more, and a fourth calculator caused the current to flow through the first negative wiring line.

### CROSS REFERENCE TO RELATED APPLICATIONS

This application is based upon and claims the benefit of priority from the prior Japanese Patent Application No. 2023-144728, filed on Sep. 6, 2023, the entire contents of which are incorporated herein by reference.

### FIELD

One or more embodiments of the present invention relate to an information processing apparatus and a memory system.

### BACKGROUND

Calculation of an inner product of vectors having a lot of elements can be performed at a high speed by using a hardware circuit. Examples of such a hardware circuit include a CIM (Computer In Memory).

Elements of a vector are not limited to have a value that is equal to or more than zero, and may have a value that is equal to or lower than zero. Therefore, a value obtained by multiplying elements of vectors may be a negative value. Since a CIM generally detects a calculation result as a change in current or voltage, a circuit configuration for dealing with a calculation result that may be a negative value becomes complicated since the current direction may be reversed or a negative voltage should be obtained.

### BRIEF DESCRIPTION OF THE DRAWINGS

FIG. 1 is a schematic diagram of a CIM for calculating the inner product of vectors.

FIG. 2A shows an example of an element multiplication table including multiplication values of all combinations of non-negative value elements.

FIG. 2B shows a distribution of values obtained by multiplying elements of two 128-dimensional vectors having non-negative value elements.

FIG. 3A shows an example of an element multiplication table including multiplication values of all combinations of integer elements.

FIG. 3B shows a distribution of values obtained by multiplying elements of two 128-dimensional vectors having integer elements.

FIG. 4 is a block diagram showing an example of a CIM calculating multiplication values of non-negative value elements.

FIG. 5 is a circuit diagram showing a specific example of the calculator shown in FIG. 4.

FIG. 6 is a block diagram of an information processing apparatus according to a first embodiment.

FIG. 7 illustrates an element multiplication table used in calculation processing performed by the calculator group shown in FIG. 6.

FIG. 8 shows block diagrams indicating first to fourth calculator groups.

FIG. 9 is a specific circuit diagram of first to fourth calculators included in the first calculator group.

FIG. 10A shows a correspondence relationship between the gate voltage of a first transistor in a string included in the first calculator of the first calculator group and the current flowing through the string.

FIG. 10B shows a correspondence relationship between the gate voltage of a first transistor in a string included in the second calculator of the second calculator group and the current flowing through the string.

FIG. 10C shows a correspondence relationship between the gate voltage of a first transistor in a string included in the third calculator of the third calculator group and the current flowing through the string.

FIG. 10D shows a correspondence relationship between the gate voltage of a first transistor in a string included in the fourth calculator of the fourth calculator group and the current flowing through the string.

FIG. 11A shows a fifth element multiplication table.

FIG. 11B shows a sixth element multiplication table.

FIG. 12A is a block diagram of an information processing apparatus according to a first modification of the first embodiment.

FIG. 12B is a block diagram of an information processing apparatus according to a second modification of the first embodiment.

FIG. 13 is a block diagram of an information processing apparatus according to a second embodiment.

FIG. 14 shows an element multiplication table of multiplications of integer elements performed by a calculator group according to the second embodiment.

FIG. 15 shows a first modified element multiplication table obtained by shifting each multiplication value of the element multiplication table by a predetermined value.

FIG. 16 shows a correspondence relationship between the gate voltage of the first transistor in the string included in each of the first calculator and the second calculator for performing the calculations of the first modified element multiplication table and the current flowing through the string.

FIG. 17 shows a second modified element multiplication table obtained by changing each multiplication value of the element multiplication table depending on the value of the query.

FIG. 18 shows the correspondence relationship between the gate voltage of the first transistor in the string 3 included in each of the first calculator and the second calculator for performing the calculations of the second modified element multiplication table and the current flowing through the string.

FIG. 19A is a block diagram of an information processing apparatus according to a first modification of the second embodiment.

FIG. 19B is a block diagram of an information processing apparatus according to a second modification of the second embodiment.

FIG. 20 is a block diagram illustrating a schematic configuration of a memory system according to a third embodiment.

FIG. 21 is a block diagram illustrating a schematic configuration of a memory system according to a modification of the third embodiment.

### DETAILED DESCRIPTION

In order to solve the aforementioned problem, an information processing apparatus according to an embodiment of the present invention is provided, the information processing apparatus being configured to perform a multiplication of a first integer element and a second integer element and including:
a first positive wiring line configured to carry a current corresponding to a multiplication value of the first integer element and the second integer element when the multiplication value is equal to or more than zero;
a first negative wiring line configured to carry a current corresponding to the multiplication value when the multiplication value is equal to or less than zero;
a second positive wiring line configured to be activated when the second integer element has a positive value;
a second negative wiring line configured to be activated when the second integer element has a negative value;
a first calculator connected to the first positive wiring line and the second positive wiring line to perform the multiplication of the first integer element and the second integer element and cause the current to flow through the first positive wiring line when the multiplication value is equal to or more than zero;
a second calculator connected to the first negative wiring line and the second positive wiring line to perform the multiplication of the first integer element and the second integer element and cause the current to flow through the first negative wiring line when the multiplication value is equal to or less than zero;
a third calculator connected to the first positive wiring line and the second negative wiring line to perform the multiplication of the first integer element and the second integer element and cause the current to flow through the first positive wiring line when the multiplication value is equal to or more than zero; and
a fourth calculator connected to the first negative wiring line and the second negative wiring line to perform the multiplication of the first integer element and the second integer element and cause the current to flow through the first negative wiring line when the multiplication value is equal to or less than zero,
a direction of the current flowing through the first positive wiring line being the same as a direction of the current flowing through the first negative wiring line,
the first integer element being a positive integer, a negative integer, or zero,
the second integer element being a positive integer, a negative integer, or zero.

Embodiments of an information processing apparatus and a memory system will now be described below with reference to the accompanying drawings. Although main parts of the information processing apparatus and the memory system will be mainly described below, the information processing apparatus and the memory system may include an element or a function that is not illustrated or described. The following descriptions do not exclude any element or function that is not illustrated or described.

### First Embodiment

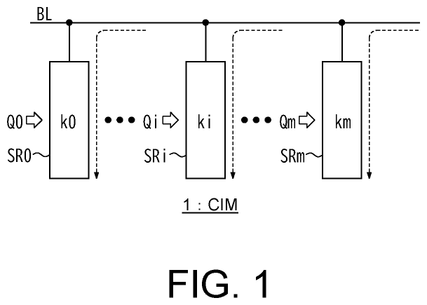

FIG. 1 is a schematic diagram of a CIM 1 for calculating the inner product of vectors. The CIM 1 includes one or more bit lines BL disposed in a memory cell array and a plurality of strings SR0 to SRm each having one end connected to the bit line BL. Each of the strings SR0 to SRm includes a plurality of memory cell transistors connected in series. The memory cell transistor will be simply called “transistor” in the following descriptions. A different word line is connected to the gate of each transistor in a string. Although, in a general memory cell array, a plurality of word lines may be commonly connected to a plurality of strings SR0 to SRm, the word lines in the configuration of FIG. 1 are not necessarily connected commonly to the plurality of strings, and different word lines may be connected to each string.

The threshold voltage of the transistors in each string is set at a value depending on a corresponding element of a first vector K (k0, k1, . . . , km) having (m+1) elements. The voltage level of one of the word lines connected to each string is set to conform to a corresponding element of a second vector Q (q0, q1, . . . , qm) having (m+1) elements. Here, m is an integer of 1 or more.

The string SR0 of the plurality of strings SR0 to SRm carries a current depending on the product of an element k0 of the first vector K and an element q0 of the second vector Q. The string Sri carries a current depending on the product of an element ki of the first vector K and an element qi of the second vector Q. The string SRm carries a current depending on the product of an element km of the first vector K and an element qm of the second vector Q.

The sum of the currents flowing through the strings SR0 to SRm is a current corresponding to the inner product value of the first vector K and the second vector Q. This current flows through the bit line BL. Therefore, the current flowing through the bit line BL changes depending on the inner product value of the first vector K and the second vector Q. As the inner product value increases, the sum of the currents flowing through the strings SR0 to SRm increases, i.e., the current flowing through the bit line BL increases, and the voltage level of the bit line BL considerably decreases.

If the first vector and the second vector include an element having a negative value, the multiplication value (product) of elements may become a negative value. If the multiplication value is a negative value, the direction of the current flowing through the bit line BL and the string is reversed. However, depending on the circuit configuration of the string, there may be a case where the direction of the current cannot be changed easily. In the embodiments described below, the direction of the current flowing through the bit line BL and the string is not changed even if an element of a vector has a negative value.

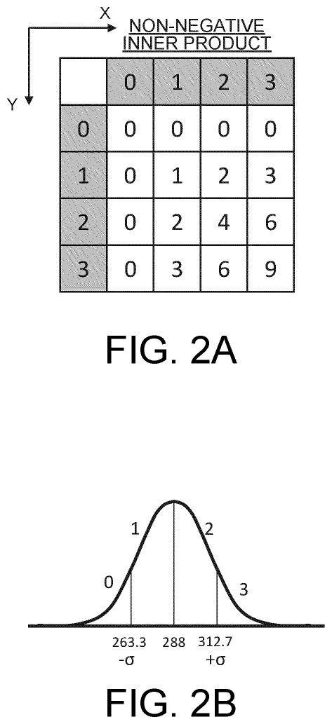

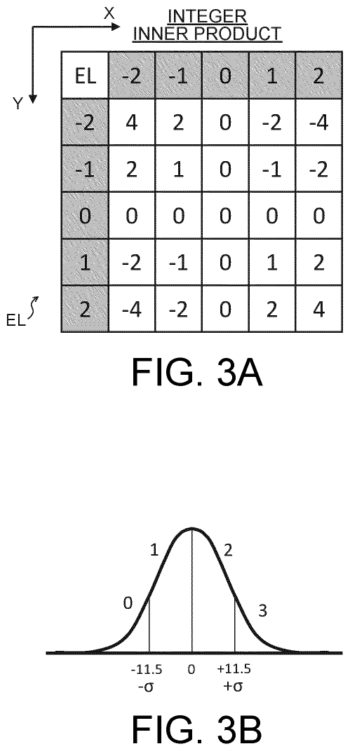

FIG. 2A shows an example of an element multiplication table including multiplication values of all combinations of elements when each element of a first vector and each element of a second vector have non-negative values (0 or more). The multiplication values shown in FIG. 2A are obtained by using the elements (0, 1, 2, 3) of the first vector arranged in the first direction X and the elements (0, 1, 2, 3) of the second vector arranged in the second direction Y.

Since the first vector and the second vector in the element multiplication table shown in FIG. 2A each include four types of elements (“four dimensional”), there are 16 combinations of elements to be multiplied, i.e., there are 16 multiplication values. The mean value μ of the 16 multiplication values is 2.25, and the standard deviation σ² is 4.763349.

If each of the first vector and the second vector are 128-dimensional, the mean value μ of the multiplication values is 288, and the standard deviation σ² is 609.7087. FIG. 2B shows a distribution of values obtained by multiplying elements of two 128-dimensional vectors having non-negative value elements. The horizontal axis of FIG. 2B represents multiplication value, and the vertical axis represents frequency. As shown in FIG. 2B, the values obtained by multiplying elements of the two vectors show, for example, a normal distribution.

FIG. 3A shows an example of an element multiplication table EL in which each element of the first vector and the second vector is an integer (positive integer, negative integer, or zero). The element multiplication table EL shown in FIG. 3A has 25 multiplication values, which are combinations of five elements (−2, −1, 0, 1, 2) of the first vector arranged in the first direction X and five elements (−2, −1, 0, 1, 2) of the second vector arranged in the second direction Y. The multiplication values shown in FIG. 3A have positive values, negative values, and zeros, and the mean value μ of the multiplication values is 0, and the standard deviation σ² is 1.036158. If the first vector and the second vector are 128-dimensional, the mean value μ of the multiplication values is 0, and the standard deviation σ² is 132.6282.

FIG. 3B shows a distribution of values obtained by multiplying elements of two 128-dimensional vectors having integer elements. Although FIG. 3B also shows a normal distribution like FIG. 2B, the multiplication value having the highest frequency is zero.

As can be understood from the comparison between FIG. 2B and FIG. 3B, the mean value μ and the standard deviation σ² of the multiplication values of the two vectors having the integer elements are smaller than the mean value μ and the standard deviation σ² of the multiplication values of the two vectors having non-negative value elements. If it is possible to decrease the mean value μ and the standard deviation σ² of the multiplication values, the power consumption may be reduced.

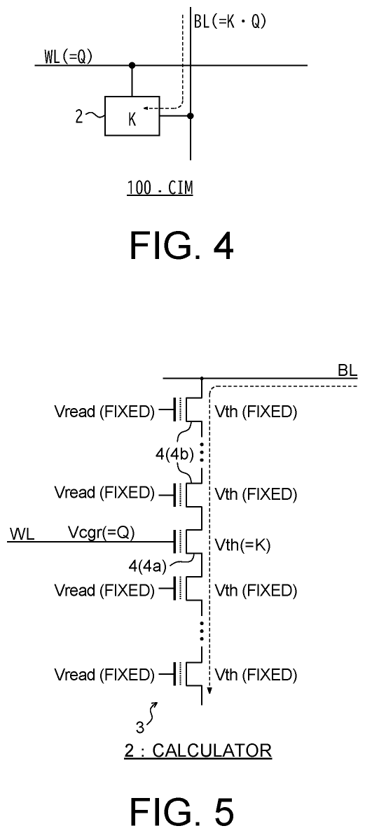

FIG. 4 is a block diagram showing an example of a CIM 100 for calculating multiplication values of non-negative value elements. The CIM 100 shown in FIG. 4 performs a multiplication of a key K and a query Q, and includes a calculator 2 connected to a word line WL and a bit line BL. The voltage of the word line WL is set at a value corresponding to the query Q. The calculator 2 includes a transistor, the threshold value of which is set at a value corresponding to the key K. The bit line BL carries a current corresponding to the multiplication value of the query Q and the key K.

For example, the key K is an element of the first vector and the query Q is an element of the second vector. Providing a plurality of calculators 2 each having the configuration shown in FIG. 4 makes it possible to calculate an inner product of the first vector and the second vector.

FIG. 5 is a circuit diagram showing a specific example of the calculator 2 illustrated in FIG. 4. The configuration of the calculator 2 illustrated in FIG. 4 is similar to that of a NAND flash memory, for example. More specifically, the calculator 2 illustrated in FIG. 4 includes a string 3 connected to the bit line BL as shown in FIG. 5. The string 3 includes a plurality of memory cell transistors 4 connected in series. In the following descriptions, the memory cell transistor 4 may be simply called “transistor 4.” Each transistor 4 of the string 3 is an NMOS transistor, for example.

The threshold voltage of one of the transistors 4 included in the string 3 (“first transistor 4a”) is set at a value corresponding to an absolute value of the key K. The gate of the first transistor 4a is connected to the word line WL. A voltage corresponding to the query Q is applied to the gate of the first transistor 4a via the word line WL.

A predetermined threshold voltage is set at each transistor (“second transistor”) 4b other than the first transistor 4a of the transistors constituting the string 3. A voltage Vread, the voltage level of which is far higher than that of the predetermined threshold voltage, is applied to the gate of the second transistor 4b. Thus, the threshold voltage and the gate voltage of each second transistor 4b have predetermined fixed values, and each second transistor 4b is in the ON state.

The number of second transistors 4b included in the string 3 may be arbitrarily determined in the range of one or more. The string 3 may also include a selection transistor that is capable of selecting whether the string 3 carries a current.

The current flowing between the drain and the source of the first transistor 4a is changed depending on the values of the query Q and the key K. Since each second transistor 4b is in the ON state, the current flowing through the string 3 depends on the current flowing between the drain and the source of the first transistor 4a, and determined by the values of the query Q and the key K.

The current flowing through the string 3 is supplied from the bit line BL. Therefore, the current flowing from the bit line BL to the string 3 depends on the values of the query Q and the key K. As the value of the key K increases, the threshold voltage set at the first transistor 4a decreases. Therefore, as the multiplication value of the query Q and the key K increases, the current flowing between the drain and the source of the first transistor 4a increases and the current flowing through the bit line BL increases, and the voltage level of the bit line BL decreases.

Thus, depending on the multiplication value of the query Q and the key K, the current flowing through the string 3 and the bit line BL changes and the voltage level of the bit line BL also changes. Therefore, the multiplication value of the query Q and the key K may be detected by detecting the value of the current flowing through the bit line BL or the voltage of the bit line BL.

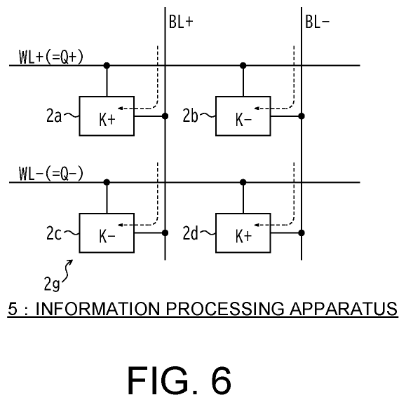

FIG. 6 is a block diagram of an information processing apparatus 5 according to a first embodiment. The information processing apparatus 5 according to the first embodiment is capable of multiplying a first integer element and a second integer element. The first integer element may be an element of a first vector. Similarly, the second integer element may be an element of a second vector.

The information processing apparatus 5 according to the first embodiment shown in FIG. 6 includes a bit line pair BL+, BL−, a word line pair WL+, WL−, and a calculator group 2g including four calculators 2 (“first calculator 2a, second calculator 2b, third calculator 2c, and fourth calculator 2d”).

One bit line of the bit line pair BL+, BL− (“first bit line BL+” or “first positive wiring line”) carries a current depending on the multiplication value of the first integer element and the second integer element if the multiplication value is equal to or more than zero. Each of the first integer element and the second integer element is a positive integer, a negative integer, or zero. The state “to carry a current depending on the multiplication value” may be a case where the current depending on the multiplication value is zero.

The other bit line of the bit line pair BL+, BL− (“second bit line BL−” or “first negative wiring line”) carries a current depending on the multiplication value of the first integer element and the second integer element if the multiplication value is equal to or less than zero.

Thus, the second bit line BL− carries a current if the multiplication value of the first integer element and the second integer element is equal to or less than zero. The direction of the current flowing through the second bit line BL− in such a case is the same as the direction of the current flowing through the first bit line BL+ when the multiplication value of the first integer element and the second integer element of the first bit line BL+ is more than zero.

One word line of the word line pair WL+, WL− (“first word line WL+” or “second positive wiring line”) is activated when the first integer element has a positive value. The other word line of the word line pair WL+, WL− (“second word line WL−” or “second negative wiring line”) is activated when the first integer element has a negative value. Activating or activation means that a voltage that is higher than a ground voltage (for example, 0 V) is applied to the first word line WL+ or the second word line WL−.

As described above, the second word line WL− is activated with the first integer element has a negative value. When the second word line WL− is activated, the voltage level of the second word line WL− is greater than a ground voltage (for example, 0 V), like the case of the first word line WL+.

The first calculator 2a is connected to the first bit line BL+ and the first word line WL+, and causes a current to flow through the first bit line BL+1 when the multiplication value of the first integer element and the second integer element is equal to or more than zero.

The second calculator 2b is connected to the second bit line BL− and the first word line WL+, and causes a current to flow through the second bit line BL− when the multiplication value of the first integer element and the second integer element is equal to or less than zero.

The third calculator 2c is connected to the first bit line BL+ and the second word line WL−, and causes a current to flow through the first bit line BL+ when the multiplication value of the first integer element and the second integer element is equal to or more than zero.

The fourth calculator 2d is connected to the second bit line BL− and the second word line WL−, and causes a current to flow through the second bit line BL− when the multiplication value of the first integer element and the second integer element is equal to or less than zero.

As will be described later, each of the first to fourth calculators 2a to 2d has a string 3 having the same configuration as that shown in FIG. 5. In each of the first to fourth calculators 2a to 2d, a voltage corresponding to the query Q may be applied to the gate of the first transistor 4a included in the string 3, and a threshold voltage corresponding to the key K may be set at the first transistor 4a. However, as will be described later, depending on the values of the key K and the query Q, whether the voltage corresponding to query Q is applied to the gate of the first transistor 4a in each of the first to fourth calculators 2a to 2d and whether the threshold voltage corresponding to the key K is set at the first transistor 4a are determined.

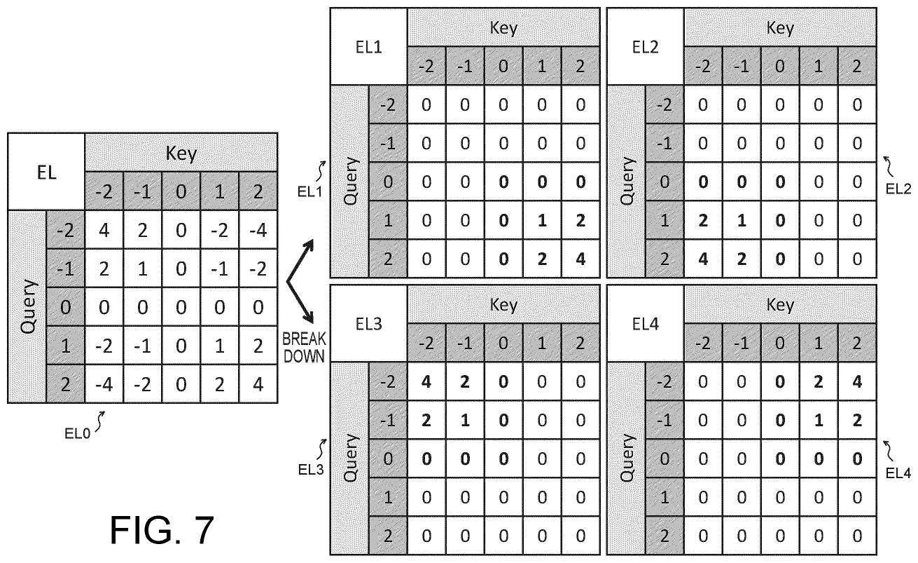

FIG. 7 illustrates an element multiplication table EL0 used in calculation processing performed by the calculator group 2g shown in FIG. 6. The element multiplication table EL0 of FIG. 7 shows 25 multiplication values corresponding to all arbitrary combinations of all possible values of the first integer element and all possible values of the second integer element. Since each of the first integer element and the second integer element may have a positive value, a negative value, or zero, the multiplication value of a first integer element and a second integer element may also be a positive value, a negative value, or zero as shown in FIG. 7. Specifically, if the first integer element and the second integer element has a value selected from 2, 1, 0, −1, and −2, the multiplication value of the first integer element and the second integer element may be 4, 2, 1, 0, −1, −2, or −4. The values of the first integer element and the second integer element are not limited to be selected from 2, 1, 0, −1, and −2 but may be selected from 1, 0, and −1, or may include values of 3 or more and −3 or less in addition to 2, 1, 0, −1, and −2.

In this embodiment, as described above, if the multiplication value is a positive value, a current corresponding to the multiplication value flows through the first bit line BL+, and if the multiplication value is a negative value, a current corresponding to the multiplication value flows through the second bit line BL−. The direction of the current flowing through the first bit line BL+ and the direction of the current flowing through the second bit line BL− are caused to be the same as each other. If the multiplication value is zero, no current flows through the first bit line BL+ or the second bit line BL−. If the query Q has a positive value, a positive voltage is applied to the first word line WL+, and if the query Q has a negative value, a positive voltage is applied to the second word line WL−. If the query Q has a value of zero, the voltage of 0 V, for example, is set at the first word line WL+ and the second word line WL−.

Depending on the combinations of positive and negative values of the key K and the query Q, the element multiplication table EL0 shown in FIG. 7 may be broken down into first to fourth element multiplication tables EL1 to EL4. The configuration of the calculator group 2g needs to be changed for each of the first to fourth element multiplication tables EL1 to EL4. In this embodiment, the configuration of the calculator group 2g for performing the calculations of the first element multiplication table EL1 is called “first calculator group 2ag,” the configuration of the calculator group 2g for performing the calculations of the second element multiplication table EL2 is called “second calculator group 2bg,” the configuration of the calculator group 2g for performing the calculations of the third element multiplication table EL3 is called “third calculator group 2cg,” and the configuration of the calculator group 2g for performing the calculations of the fourth element multiplication table EL4 is called “fourth calculator group 2dg.”

The first element multiplication table EL1 includes multiplication values in the lower right 3×3 cells of the original element multiplication table EL0. The multiplication values in the other cells are forcibly set to zero. The first calculator group 2ag for performing the calculations of the first element multiplication table EL1 performs calculations of the values in the lower right 3×3 cells in the original element multiplication table EL0, and also calculations for changing the values of the other cells to zero.

The second element multiplication table EL2 includes values obtained by changing the multiplication values in the lower left 3×3 cells of the original element multiplication table EL0 to positive values. The multiplication values in the other cells are forcibly set to zero. The second calculator group 2bg for performing the calculations of the second element multiplication table EL2 performs calculations of the values in the lower left 3×3 cells of the original element multiplication table EL0, and also calculations for changing the values of the other cells to zero.

The third element multiplication table EL3 includes multiplication values in the upper left 3×3 cells of the original element multiplication table EL0. The multiplication values in the other cells are forcibly set to zero. The third calculator group 2cg for performing the calculations of the third element multiplication table EL3 performs calculations of the values in the upper left 3×3 cells in the original element multiplication table EL0, and also calculations for changing the values of the other cells to zero.

The fourth element multiplication table EL4 includes values obtained by changing the multiplication values in the upper right 3×3 cells of the original element multiplication table EL0 to positive values. The multiplication values in the other cells are forcibly set to zero. The fourth calculator group 2dg for performing the calculations of the fourth element multiplication table EL4 performs calculations of the values in the upper right 3×3 cells in the original element multiplication table EL0, and also calculations for changing the values of the other cells to zero.

In the information processing apparatus 5 according to the first embodiment, if the first integer element is equal to or more than zero and the second integer element is equal to or more than zero, a current corresponding to the multiplication value calculated by the first calculator 2a flows through the first positive wiring line. The multiplication values calculated by the second calculator 2b, the third calculator 2c, and the fourth calculator 2d are zero. The calculation is thus performed by using the first calculator group 2ag.

If the first integer element is equal to or less than zero and the second integer element is equal to or more than zero, a current corresponding to the multiplication value calculated by the second calculator 2b flows through the first negative wiring line. The multiplication values calculated by the first calculator 2a, the third calculator 2c, and the fourth calculator 2d are zero. The calculation is thus performed by using the second calculator group 2bg.

If the first integer element is equal to or less than zero and the second integer element is equal to or less than zero, a current corresponding to the multiplication value calculated by the third calculator 2c flows through the first positive wiring line. The multiplication values calculated by the first calculator 2a, the second calculator 2b, and the fourth calculator 2d are zero. The calculation is thus performed by using the third calculator group 2cg.

If the first integer element is equal to or more than zero and the second integer element is equal to or less than zero, a current corresponding to the multiplication value calculated by the fourth calculator 2d flows through the first negative wiring line. The multiplication values calculated by the first calculator 2a, the second calculator 2b, and the third calculator 2c are zero. The calculation is thus performed by using the fourth calculator group 2dg.

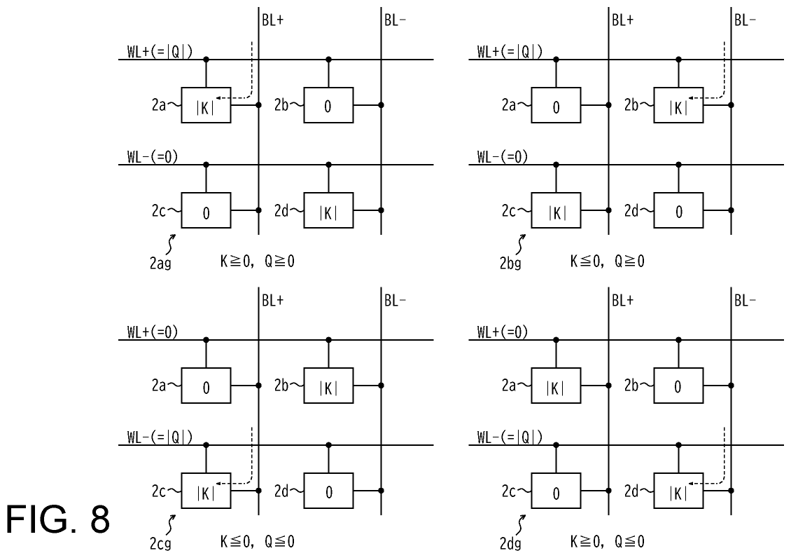

FIG. 8 shows block diagrams indicating the first calculator group 2ag for performing calculations of the first element multiplication table EL1, the second calculator group 2bg for performing calculations of the second element multiplication table EL2, the third calculator group 2cg for performing calculations of the third element multiplication table EL3, and the fourth calculator group 2dg for performing calculations of the fourth element multiplication table EL4.

In the first calculator group 2ag, the first calculator 2a and the fourth calculator 2d perform the multiplication of the key K and the query Q, and the second calculator 2b and the third calculator 2c make the multiplication value zero regardless of the values of the key K and the query Q. Since a voltage of 0 V is applied to the first word line WL+ depending on the query Q, the first calculator 2a outputs a multiplication value that is zero or more. Since the voltage of the second word line WL− is fixed to 0 V, the fourth calculator 2d outputs zero as the multiplication value regardless of the value of the key K. Thus, in the first calculator group 2ag, the first calculator 2a performs the multiplications in the lower right 3×3 cells of the first element multiplication table EL1 shown in FIG. 7, and the second calculator 2b to the fourth calculator 2d output zero as the multiplication values. Therefore, a current corresponding to the multiplication value calculated by the first calculator 2a flows through the first bit line BL+. No current flows through the second bit line BL−.

In the second calculator group 2bg, the second calculator 2b and the third calculator 2c perform the multiplication of the key K and the query Q, and the first calculator 2a and the fourth calculator 2d make the multiplication value zero regardless of the values of the key K and the query Q. Since a voltage of 0 V or more is applied to the first word line WL+ depending on the query Q, the multiplication value outputted from the second calculator 2b is zero or more. Since the voltage of the second word line WL− is fixed to 0 V, the third calculator 2c outputs zero as the multiplication value regardless of the value of the key K. Thus, in the second calculator group 2bg, the second calculator 2b performs the multiplications in the lower left 3×3 cells of the second element multiplication table EL2 shown in FIG. 7, and the first calculator 2a, the third calculator 2c, and the fourth calculator 2d output zero as the multiplication values. Therefore, a current corresponding to the multiplication value calculated by the second calculator 2b flows through the second bit line BL−. No current flows through the first bit line BL+.

In the third calculator group 2cg, the second calculator 2b and the third calculator 2c perform the multiplication of the key K and the query Q, and the first calculator 2a and the fourth calculator 2d make the multiplication value zero regardless of the values of the key K and the query Q. Since the voltage of the first word line WL+ is fixed to 0 V, the second calculator 2b outputs zero as the multiplication value regardless of the value of the key K. Since a voltage of 0 V or more is applied to the second word line WL− depending on the value of the query Q, the third calculator 2c outputs a multiplication value of 0 or more. Thus, in the third calculator group 2cg, the third calculator 2c performs the multiplications of the upper left 3×3 cells of the third element multiplication table EL3 shown in FIG. 7, and the first calculator 2a, the second calculator 2b, and the fourth calculator 2d output zero as the multiplication values. Therefore, a current corresponding to the multiplication value calculated by the third calculator 2c flows through the first bit line BL+. No current flows through the second bit line BL−.

In the fourth calculator group 2dg, the first calculator 2a and the fourth calculator 2d perform the multiplication of the key K and the query Q, and the second calculator 2b and the third calculator 2c make the multiplication value zero regardless of the values of the key K and the query Q. Since the voltage of the first word line WL+ is fixed to 0 V, the first calculator 2a outputs zero regardless of the value of the key K. Since a voltage of 0 V or more is applied to the second word line WL− depending on the value of the query Q, the fourth calculator 2d outputs a multiplication value of 0 or more. Thus, in the fourth calculator group 2dg, the fourth calculator 2d performs the multiplications of of the upper right 3×3 cells of the fourth element multiplication table EL4 shown in FIG. 7, and the first calculator 2a to the third calculator 2c output zero as the multiplication values. Therefore, a current corresponding to the multiplication value calculated by the fourth calculator 2d flows through the second bit line BL−. No current flows through the first bit line BL+.

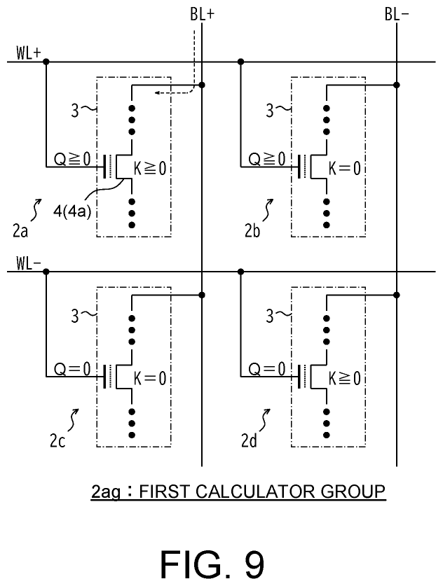

FIG. 9 is a specific circuit diagram of the first to fourth calculators 2a to 2d included in the first calculator group 2ag. As shown in FIG. 9, each of the first to fourth calculators 2a to 2d includes a string 3. Like the string 3 shown in FIG. 5, the string 3 has a first transistor 4a and a second transistor 4b connected in series. In the example of FIG. 9, however, the second transistor 4b is not shown. The gate of the first transistor 4a is connected to the first word line WL+ or the second word line WL−. Since the query Q is zero or more for the first calculator group 2ag depending on the value of the query Q, a voltage of 0 V or more is applied to the gate of the first transistor 4a in the string 3 included in the first calculator 2a and the second calculator 2b via the first word line WL+. A voltage of 0 V is applied to the gate of the first transistor 4a in the string 3 included in the third calculator 2c and the fourth calculator 2d of the first calculator group 2ag via the second word line WL−.

A threshold voltage corresponding to the value of the key K is set at the first transistor 4a of the string 3 in the first calculator 2a. As the key K increases, the threshold voltage decreases, which causes a current to flow between the drain and the source of the first transistor 4a more easily. The current flowing between the drain and the source of the first transistor 4a of the first calculator 2a changes depending on the difference between the voltage corresponding to the query Q inputted to the gate of the first transistor 4a and the threshold voltage corresponding to the key K set to the first transistor 4a. Thus, the current flowing between the drain and the source of the first transistor 4a changes depending on the multiplication value of the key K and the query Q.

The current flowing through the string 3 of the first calculator 2a is determined by the difference between the gate voltage and the threshold voltage of the first transistor 4a in the string 3. Thus, current flowing through the string 3 of the first calculator 2a depends on the multiplication value of the query Q and the key K.

A high threshold voltage corresponding to the case where the key K is zero is set at the first transistor 4a in each string 3 of the second calculator 2b and the third calculator 2c. Therefore, the first transistor 4a is always in the OFF state.

The threshold voltage set at the first transistor 4a in the string 3 of the fourth calculator 2d depends on the key K. Since 0 V is inputted to the gate thereof, the first transistor 4a is in the OFF state, and no current flows between the drain and the source thereof.

Thus, no current flows through the string 3 of each of the second to fourth calculators 2b to 2d in the first to fourth calculators 2a to 2d constituting the first calculator group 2ag. On the other hand, a current corresponding to the multiplication value of the key K and the query Q flows through the string 3 of the first calculator 2a. This current flows through the first bit line BL+.

Although FIG. 9 does not show the details, a current corresponding to any of the multiplication values in the second to fourth element multiplication tables EL2 to EL4 is caused to flow through the first bit line BL+ or the second bit line BL− by controlling the threshold voltage and the gate voltage of the first transistor 4a in the string 3 of each of the first to fourth calculators 2a to 2d included in the second calculator group 2bg to the fourth calculator group 2dg in a similar manner. Therefore, it is not necessary to separately provide first to fourth calculators 2a to 2d for the calculations in the first calculator group 2ag to the fourth calculator group 2dg. Depending on the sign (positive or negative) of the key K and the query Q, which of the first calculator group 2ag, the second calculator group 2bg, the third calculator group 2cg, and the fourth calculator group 2dg is used is determined, and depending on the determined calculator group, the threshold voltage of the first transistor 4a in the string 3 of each of the first to fourth calculators 2a to 2d and the voltages of the first word line WL+ and the second word line WL− are controlled, so that the multiplication of the key K and the query Q is performed using one of the first to fourth calculators 2a to 2d corresponding to the determined calculator group to cause a current corresponding to the multiplication result to flow through the first bit line BL+ or the second bit line BL−.

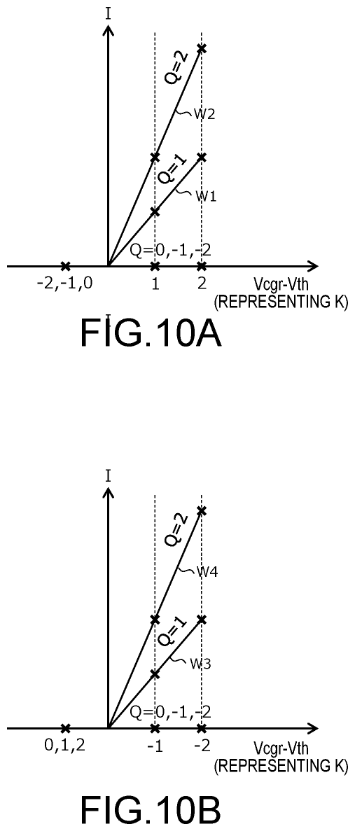

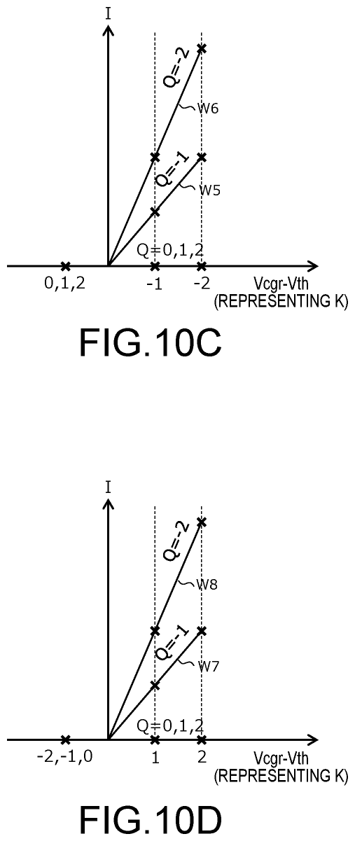

FIG. 10A shows a correspondence relationship between the gate voltage of the first transistor 4a in the string 3 included in the first calculator 2a and the current flowing through the string 3 in the first calculator group 2ag for performing the calculation of the first element multiplication table EL1. The horizontal axis in FIG. 10A represents voltage difference between the voltage Vcgr of the first word line WL+ corresponding to the query Q and the threshold voltage Vth of the first transistor 4a in the string 3 of the first calculator 2a corresponding to the key K. The vertical axis represents current flowing through the string 3. In FIG. 10A, a straight line W1 indicates a case where the query Q is 1, and a straight line W2 indicates a case where the query Q is 2.

As may be understood from the straight lines W1 and W2, as the potential difference (Vcgr−Vth) increases or the query Q increases, the current flowing through the first bit line BL+ and the string 3 increases. This means that as the multiplication value of the key K and the query Q increases, the current drawn from the first bit line BL+ to the string 3 increases.

FIG. 10B shows a correspondence relationship between the gate voltage of the first transistor 4a in the string 3 included in the second calculator 2b and the current flowing through the string 3 in the second calculator group 2bg for performing the calculation of the second element multiplication table EL2. What are indicated by the horizontal axis and the vertical axis are the same as those in FIG. 10A, but the positive direction of the horizontal axis is the direction in which the absolute value of the negative value of the potential difference (Vcgr−Vth), i.e., the key K, increases. In FIG. 10B, a straight line W3 indicates the case where the query Q is 1, and a straight line W4 indicates the case where the query Q is 2.

As may be understood from the straight lines W3 and W4, as the absolute value of the potential difference (Vcgr−Vth) increases or the query Q increases, the current flowing through the second bit line BL− and the string 3 increases. This means that as the absolute value of the negative multiplication value of the key K and the query Q increases, the current drawn from the second bit line BL− to the string 3 increases.

FIG. 10C shows a correspondence relationship between the gate voltage of the first transistor 4a in the string 3 included in the third calculator 2c and the current flowing through the string 3 in the third calculator group 2cg for performing the calculation of the third element multiplication table EL3. What are indicated by the horizontal axis and the vertical axis are the same as those in FIG. 10A, but the positive direction of the horizontal axis is the direction in which the absolute value of the negative value of the potential difference (Vcgr−Vth), i.e., the key K, increases. In FIG. 10C, a straight line W5 indicates the case where the query Q is −1, and a straight line W6 indicates the case where the query Q is −2.

As may be understood from the straight lines W5 and W6, as the absolute value of the potential difference (Vcgr−Vth) increases or the absolute value of the query Q increases, the current flowing through the second bit line BL+ and the string 3 increases. This means that as the absolute value of the multiplication value of the key K and the query Q increases, the current drawn from the second bit line BL+ to the string 3 increases.

FIG. 10D shows a correspondence relationship between the gate voltage of the first transistor 4a in the string 3 included in the fourth calculator 2d and the current flowing through the string 3 in the fourth calculator group 2dg for performing the calculation of the fourth element multiplication table EL4. What are indicated by the horizontal axis and the vertical axis are the same as those in FIG. 10A. In FIG. 10D, a straight line W7 indicates the case where the query Q is −1, and a straight line W8 indicates the case where the query Q is −2.

As may be understood from the straight lines W7 and W8, as the potential difference (Vcgr-Vth) increases or the absolute value of the negative value of the query Q increases, the current flowing through the second bit line BL− and the string 3 increases. This means that as the absolute value of the negative multiplication value between the key K and the query Q increases, the current drawn from the second bit line BL− to the string 3 increases.

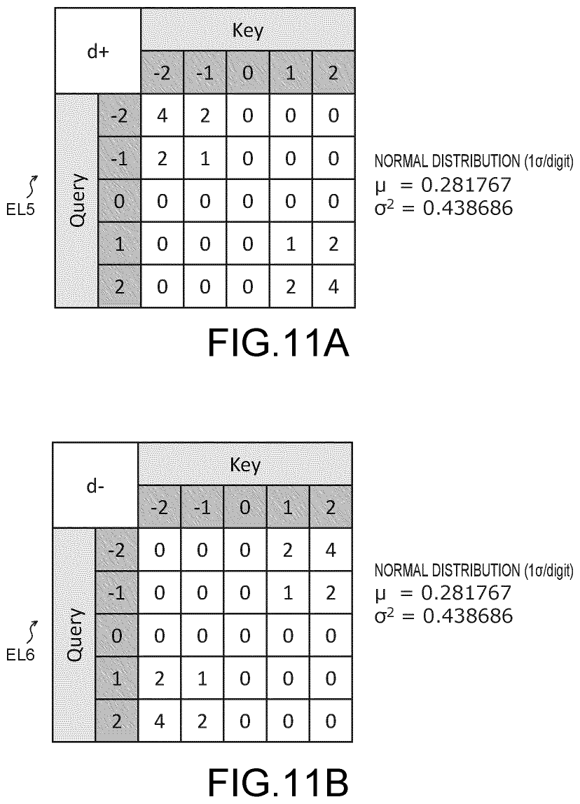

FIG. 11A and FIG. 11B are formed from the element multiplication table EL0 shown in FIG. 7. FIG. 11A shows a fifth element multiplication table EL5 for causing a current to flow through the first bit line BL+ and FIG. 11B shows a sixth element multiplication table EL6 for causing a current to flow through the second bit line BL−. Originally, the multiplication values in the sixth element multiplication table EL6 include negative values, but in order to cause a current to flow through the second bit line BL− in the same direction as the current flowing through the first bit line BL+, all the multiplication values in the sixth element multiplication table EL6 are changed to positive values.

As shown in FIGS. 11A and 11B, the mean value μ of the multiplication values is 0.281767, the standard deviation σ² is 0.438686, and the multiplication values show a normal distribution for both of the fifth element multiplication table EL5 and the sixth element multiplication table EL6. In contrast, the mean value μ of the multiplication values is 0 and the standard deviation σ² is 1.036158 in the original element multiplication table EL0 shown in FIG. 7. It is considered from the comparison between the fifth and sixth element multiplication tables EL5 and EL6 and the original element multiplication table EL0 that although the mean value becomes slightly higher, the standard deviation considerably decreases in the case of the fifth and sixth element multiplication tables EL5 and EL6.

An example in which the single calculator group 2g is connected to the bit line pair BL+, BL− including the first bit line BL+ and the second bit line BL− has been described with reference to FIG. 6. However, more than one calculator group 2g may be connected to the bit line pair BL+, BL−.

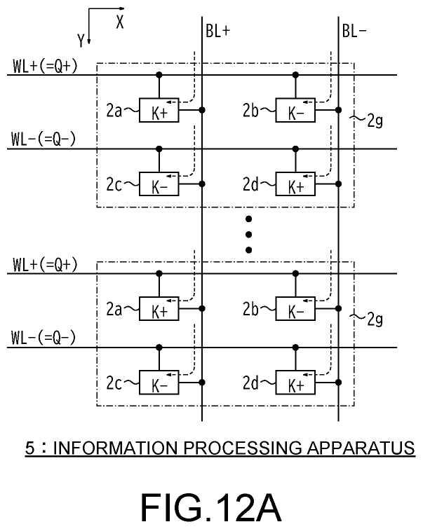

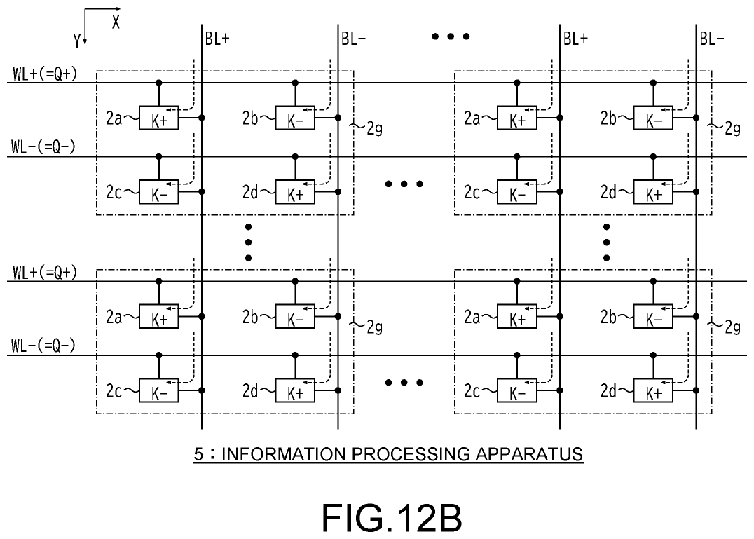

FIG. 12A is a block diagram of an information processing apparatus 5 according to a first modification of the first embodiment. The information processing apparatus 5 according to the first modification includes a plurality of calculator groups 2g connected to the bit line pair BL+, BL− and a plurality of word line pairs WL+, WL− each connected to a plurality of the calculator groups 2g. The configuration of each of the calculator groups 2g is the same as that shown in FIG. 6.

Each of the calculator groups 2g draws a current corresponding to the multiplication value of the key K and the query Q from the first bit line BL+ or the second bit line BL−. The current flowing through the first bit line BL+ corresponds to the sum of positive multiplication values calculated by the calculator groups 2g, and a voltage depending on the current is applied to the first bit line BL+. The current flowing through the second bit line BL− corresponds to the sum of the negative multiplication values calculated by the calculator groups 2g, and a voltage depending on the current is applied to the second bit line BL−.

Thus, the information processing apparatus 5 shown in FIG. 12A transmits the result of the multiply-accumulate operation of positive multiplication values via the first bit line BL+ and the result of the multiply-accumulate operation of negative multiplication values via the second bit line BL−. As will be described later, a final result of the multiply-accumulate operations performed by the calculator groups 2g shown in FIG. 12A can be generated by obtaining a difference between the voltage of the first bit line BL+ and the voltage of the second bit line BL− by the subsequent circuitry connected after the information processing apparatus 5.

FIG. 12B is a block diagram of an information processing apparatus 5 according to a second modification of the first embodiment. The information processing apparatus 5 according to the second modification performs multiplications of a plurality of first integer elements of a first vector and a plurality of second integer elements of a second vector.

The information processing apparatus 5 according to the second modification includes a plurality of bit line pairs BL+, BL−, at least one calculator group 2g connected to each bit line pair BL+, BL−, and at least one word line pair WL+, WL−.

The bit line pairs BL+, BL− are arranged in a first direction X and each extend in a second direction Y that crosses the first direction X. One calculator group 2g is disposed at an intersection between one bit line pair BL+, BL− and one word line pair WL+, WL−.

The information processing apparatus 5 according to the second modification is capable of performing multiplications between a plurality of pairs of elements in parallel using a plurality of bit line pairs BL+, BL−. Therefore, multiplications of a plurality of first integer elements in a first vector and a plurality of second integer elements of a second vector can be performed in parallel, and it is possible to calculate the inner product value of the first vector and the second vector at a high speed.

As described above, the information processing apparatus 5 according to the first embodiment is capable of performing a multiplication of a first integer elements and a second integer element, which may have a negative value, by a hardware circuit such as the CIM 1 without changing the direction of the current. This enables the hardware circuit to perform multiply-accumulate operations including a negative value used in in machine learning, for example.

In order to perform a multiplication of a first integer element and a second integer element, which may have a negative value, the first embodiment includes the first word line WL+ for inputting the query Q having a value of zero or more, the second word line WL− for inputting the query Q having a value of zero or less, the first bit line BL+ that carries a current corresponding to a multiplication value of zero or more, and the second bit line BL− that carries a current corresponding to a multiplication value of zero or less. A voltage of 0 V or more is applied to the first word line WL+ and the second word line WL−, and the currents flowing through the first bit line BL+ and the second bit line BL− are in the same direction. Depending on whether the key K and the query Q are zero or more or zero or less, the element multiplication table EL0 used for obtaining the multiplication values of the key K and the query Q are broken down into the first to fourth element multiplication tables EL1 to EL4, and depending on which of the first to fourth element multiplication tables EL1 to EL4 is used, the configuration of the calculator group 2g is changed. Specifically, the first to fourth calculator groups 2ag to 2dg for performing the operations of the first to fourth element multiplication tables EL1 to EL4 are provided. As a result, even if a negative value is included in the key K and the query Q, polarities of the voltages applied to the first and second word lines WL+, WL− are made the same, and the directions of the currents flowing through the first and second bit lines BL+, BL− are made the same. According to the first embodiment, it is possible to perform the multiplication of the key K and the query Q with a simple circuit configuration without increasing the average amount of the currents flowing through the first bit line BL+ and the second bit line BL−.

### Second Embodiment

The information processing apparatus 5 according to the first embodiment requires the calculator group 2g including the four calculators 2 for performing a multiplication of a pair of integer elements. Therefore, the area efficiency of the information processing apparatus 5 according to the first embodiment is not good. An information processing apparatus 5 according to a second embodiment is proposed to improve the area efficiency as compared to the first embodiment.

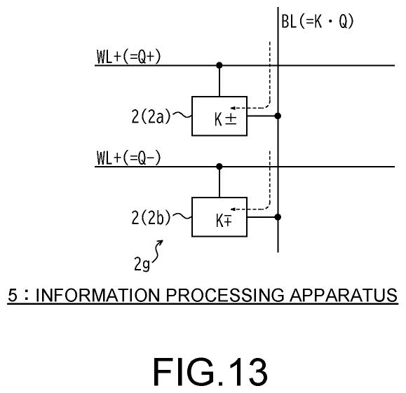

FIG. 13 is a block diagram of the information processing apparatus 5 according to the second embodiment. The information processing apparatus 5 according to the second embodiment includes a bit line BL, a word line pair WL+, WL−, and a calculator group 2g having two calculators 2 (first calculator 2a and second calculator 2b).

The bit line BL carries a current corresponding to the multiplication value of the first integer element and the second integer element. In the second embodiment, the bit line BL only carries the current in one direction. The first integer element and the second integer element may have a value of a positive integer, a negative integer, or zero.

As will be described later, in the second embodiment, even if at least one of the key K and the query Q has a negative value, the bit line BL carries a current corresponding to a corrected multiplication value obtained by correcting the multiplication value of the key K and the query Q so as to be zero or more (“corrected multiplication value”).

The first word line WL+ is activated when the second integer element (query Q) has a positive value. The second word line WL− is activated when the first integer element has a negative value. A voltage of 0 V depending on the absolute value of the query Q is applied to the first word line WL+ and the second word line WL−.

The first calculator 2a is connected to the bit line BL and the first word line WL+, and causes a current corresponding to the multiplication value of the first integer element and the second integer element to flow through the bit line BL.

The second calculator 2b is connected to the bit line BL and the second word line WL−, and causes a current corresponding to the multiplication value of the first integer element and the second integer element to flow through the bit line BL.

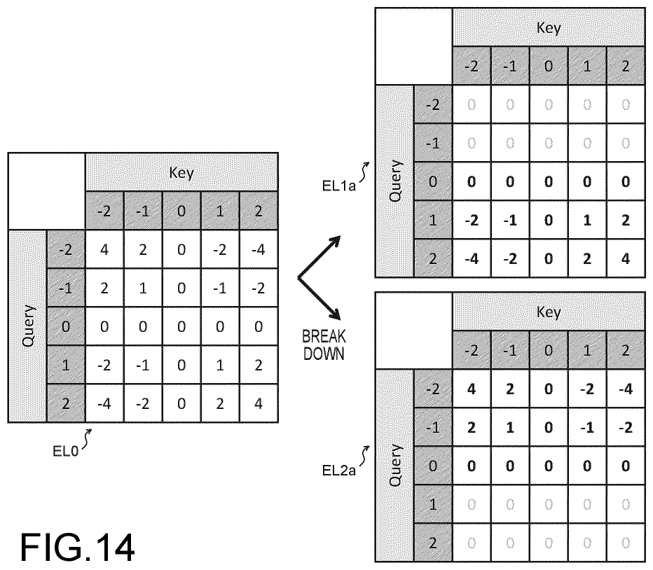

FIG. 14 shows an element multiplication table EL0 of multiplications of integer elements performed by the calculator group 2g according to the second embodiment. The element multiplication table EL0 shown in FIG. 14 is the same as the element multiplication table EL0 shown in FIG. 7, and the multiplication values are any of 4, 2, 1, 0, −1, −2, and −4.

The element multiplication table EL0 shown in FIG. 14 can be broken down into a first element multiplication table EL1a and a second element multiplication table EL2a depending on whether the query Q has a positive value or a negative value. The first element multiplication table EL1a shown in FIG. 14 is obtained by extracting multiplication values from the element multiplication table EL0 when the query Q is zero or more, and the second element multiplication table EL2a is obtained by extracting multiplication values from the element multiplication table EL0 when the query Q is zero or less. The case where the query Q is zero is included in both the first element multiplication table EL1a and the second element multiplication table EL2a. For example, the calculation of the first element multiplication table EL1a is performed by the first calculator 2a shown in FIG. 13, and the calculation of the second element multiplication table EL2a is performed by the second calculator 2b shown in FIG. 13. Since the multiplication values in the first element multiplication table EL1a and the second element multiplication table EL2a include positive values and negative values, the direction of the current flowing through the bit line BL needs to be switched depending on the multiplication value. In the information processing apparatus 5 according to the second embodiment, the bit line BL always carries a current in the same direction.

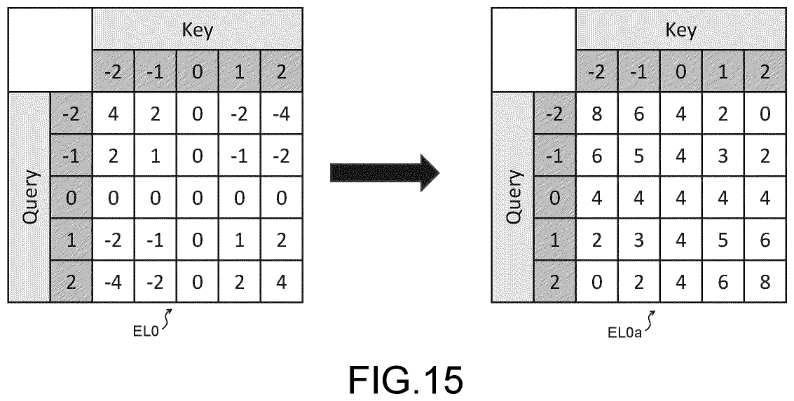

FIG. 15 shows a first modified element multiplication table EL0a obtained by shifting each multiplication value of the element multiplication table EL0 by a predetermined value (for example, +4). In the first modified element multiplication table EL0a shown in FIG. 15, the predetermined value is set as the maximum value (=+4) of the absolute values of the negative multiplication values in the element multiplication table EL0. Therefore, although the maximum value of the multiplication values in the element multiplication table EL0 is 4 and the minimum value is −4, the maximum value of the multiplication values in the first modified element multiplication table EL0a is 8 and the minimum value is 0. As a result, the mean value μ of the multiplication values of the first modified element multiplication table EL0a is 4 and the standard deviation σ² is 1.036. Since all the multiplication value are zero or more in the first modified element multiplication table EL0a, the mean value μ thereof becomes greater than the mean value μ (=0) of the original element multiplication table EL0.

Thus, the first calculator 2a and the second calculator 2b generate a first corrected multiplication value and a second corrected multiplication value by adding to the multiplication value of the first integer element and the second integer element a value that is equal to or more than the maximum value of the absolute values of the negative values in the multiplication values each obtained by multiplying any possible value of the first integer element by any possible value of the second integer element.

The first calculator 2a shown in FIG. 13 performs calculations of the lower half of the first modified element multiplication table EL0a shown in FIG. 15, and the second calculator 2b performs calculations of the upper half of the first modified element multiplication table EL0a shown in FIG. 15.

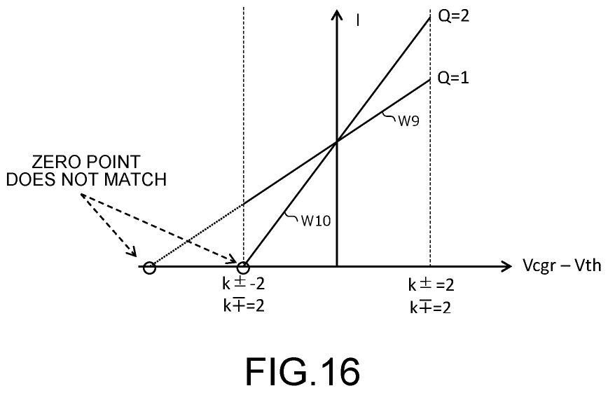

FIG. 16 shows the correspondence relationship between the gate voltage of the first transistor 4a in the string 3 included in each of the first calculator 2a and the second calculator 2b for performing the calculations of the first modified element multiplication table EL0a and the current flowing through the string 3. The horizontal axis of FIG. 16 represents the voltage difference between the voltage Vcgr of the first word line WL+ or the second word line WL− corresponding to the query Q and the threshold voltage Vth the first transistor 4a in the string 3 included in the first calculator 2a or the second calculator 2b corresponding to the key K. The vertical axis represents current flowing through the string 3.

A straight line W9 in FIG. 16 indicates a case where the query Q is 1 or −1, and a straight line W10 indicates a case where the query Q is 2 or −2. As shown in FIG. 16, the value of the voltage difference (Vcgr−Vth) when the current flowing through the string 3 is zero (zero point) differs between the straight line W9 and the straight line W10.

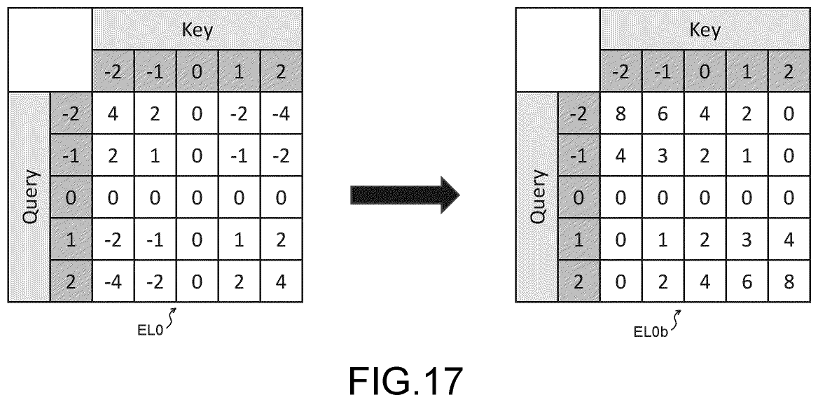

FIG. 17 shows a second modified element multiplication table EL0b obtained by changing each multiplication value of the element multiplication table EL0 depending on the value of each query Q. When the query Q is 1 or −1 in the element multiplication table EL0, the multiplication value is shifted by +2 and when the query Q is 2 or −2, the multiplication value is shifted by +4 to obtain the second modified element multiplication table EL0b shown in FIG. 17.

The first calculator 2a and the second calculator 2b generate a first corrected multiplication value and a second corrected multiplication value by adding to a multiplication value of the first integer element and the second integer element a value that is equal to or more than the maximum value of the absolute values of the negative values for which the second integer element (query Q) is the same and the first integer element (key K) is different. The second modified element multiplication table EL0b includes the first corrected multiplication values (=+2) and the second corrected multiplication values (=+4).

In other words, the first calculator 2a and the second calculator 2b generate the first corrected multiplication value and the second corrected multiplication value by adding to the multiplication values of the first integer element and the second integer element a value that is equal to or more than the maximum value of absolute values of the negative values among the multiplication values obtained from arbitrary combinations of all possible values of the first integer element and all possible values of the second integer element.

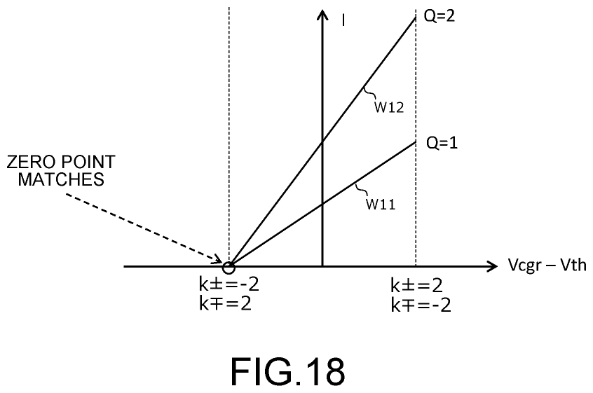

FIG. 18 shows the correspondence relationship between the gate voltage of the first transistor 4a in the string 3 included in each of the first calculator 2a and the second calculator 2b for performing the calculation of the second modified element multiplication table EL0b and the current flowing through the string 3. What are represented by the horizontal axis and the vertical axis of FIG. 18 are the same as those in FIG. 16.

A straight line W11 in FIG. 18 indicates a case where the query Q is 1 or −1, and a straight line W12 indicates a case where the query Q is 2 or −2. As shown in FIG. 18, when the current flowing through the string 3 is zero, the value of the voltage difference (Vcgr−Vth) is the same for the straight lines W11 and W12.

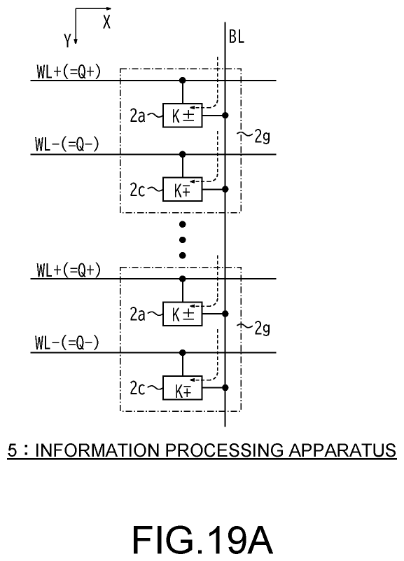

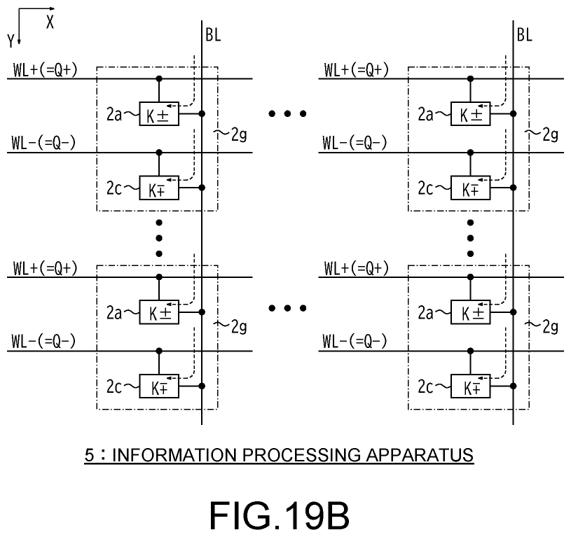

FIG. 19A is a block diagram of an information processing apparatus 5 according to a first modification of the second embodiment. The information processing apparatus 5 according to the first modification includes a plurality of calculator groups 2g connected to a bit line BL, and a plurality of word line pairs WL+, WL− connected to the calculator groups 2g. The configuration of each calculator group 2g is the same as that shown in FIG. 13.

Each of the calculator groups 2g draws a current corresponding to the multiplication value of the key K and the query Q from the bit line BL. The current flowing through the bit line BL corresponds to the multiplication values calculated by the calculator groups 2g, and the voltage applied to the bit line BL drops to a value corresponding to the current.

Thus, in the information processing apparatus 5 shown in FIG. 19A, the current flowing through the bit line BL corresponds to the result of the multiply-accumulate operations of the key K and the query Q calculated by the calculator groups 2g, and the voltage of the bit line BL changes depending on the result of the multiply-accumulate operation.

FIG. 19B is a block diagram of an information processing apparatus 5 according to a second modification of the second embodiment. The information processing apparatus 5 according to the second modification includes a plurality of bit lines BL, at least one calculator group 2g connected to each bit line BL, and at least one word line pair WL+, WL−.

The bit lines BL are arranged in a first direction X and extend in a second direction Y that crosses the first direction X. At each intersection between any of the bit lines BL and any of the word line pairs WL+, WL−, one of the calculator groups 2g is disposed.

The information processing apparatus 5 according to the second modification is capable of performing multiplications of a plurality of elements and a plurality of elements in parallel using the plurality of bit lines BL. Since the multiplications of the plurality of first integer elements in the first vector and the plurality of second integer elements in the second vector can be performed in parallel, it is possible to calculate the inner product value of the first vector and the second vector at a high speed.

As described above, the information processing apparatus 5 according to the second embodiment is capable of calculating the multiplication value of the first integer element and the second integer element by using the two calculators 2, the word line pair WL+, WL−, and the bit line BL, and therefore downsizing the circuit area as compared to the first embodiment. It is possible to transmit the multiplication result of elements via the single bit line BL without changing the direction of the current flowing through bit line BL by performing calculations based on the first modified element multiplication table EL0a or the second modified element multiplication table EL0b, the first modified element multiplication table EL0a being obtained by shifting the multiplication values in the element multiplication table EL0, which shows the result of the multiplications of the first integer element and the second integer element, based on the maximum value of the absolute values of the negative values in the element multiplication table EL0, and the second modified element multiplication table EL0b being obtained by shifting the multiplication values in the element multiplication table EL0 by a value determined based on the value of the query Q.

### Third Embodiment

The information processing apparatuses 5 according to the first and second embodiments may be incorporated into a memory system.

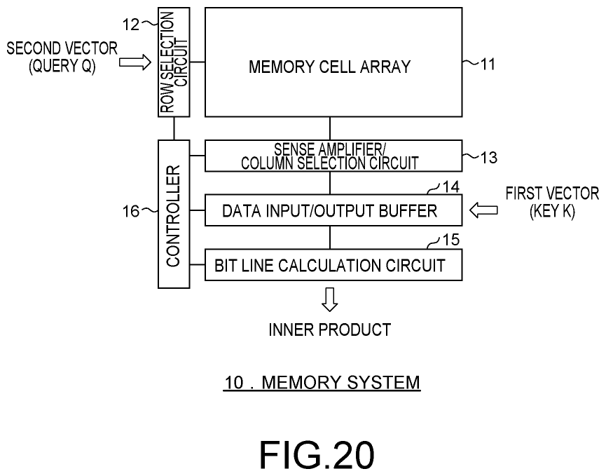

FIG. 20 is a block diagram illustrating a schematic configuration of a memory system 10 according to a third embodiment. The memory system 10 according to the third embodiment includes a memory cell array 11, a row selection circuit 12, a sense amplifier/column selection circuit 13, a data input/output buffer 14, a bit line calculation circuit 15, and a controller 16, as shown in FIG. 20.

The memory cell array 11 may include one or more bit lines BL and a plurality of strings 3 each connected to one of the bit lines BL like the circuit shown in FIG. 5. Each string 3 includes a first transistor 4a and a second transistor 4b connected in series.

The memory cell array 11 may include a calculator group 2g including first to fourth calculators 2a to 2d shown in FIG. 6, a bit line pair BL+, BL− including a first bit line BL+ and a second bit line BL−, and a word line pair WL+, WL− including a first word line WL+ and a second word line WL−.

The row selection circuit 12 controls the gate voltages of the first transistor 4a and the second transistor 4b in each string 3 according to a command from the controller 16. More specifically, the row selection circuit 12 controls the voltage depending on the query Q of the first word line WL+ connected to the gate of the first transistor 4a in each of the first calculator 2a and the second calculator 2b, and the voltage depending on the query Q of the second word line WL− connected to the gate of the first transistor 4a in each of the third calculator 2c and the fourth calculator 2d.

The sense amplifier/column selection circuit 13 senses the voltage of each bit line BL. If there are more than one bit line pair BL+, BL−, the voltage of each bit line pair BL+, BL− is sequentially selected and an output is serially made, or the voltages of the bit line pairs BL+, BL− are selected in parallel and outputs are made in parallel.

The data input/output buffer 14 supplies a signal sensed by the sense amplifier/column selection circuit 13 to the bit line calculation circuit 15 and also supplies data (key K) including an externally outputted first vector K to the sense amplifier/column selection circuit 13.

The bit line calculation circuit 15 calculates and obtains a value corresponding a voltage difference or a current difference between voltages or currents of the first bit line BL+ and the second bit line BL− in the bit line pair BL+, BL−. The bit line calculation circuit 15 includes such circuits as a complement generation circuit and an addition circuit.

The controller 16 controls the row selection circuit 12, the sense amplifier/column selection circuit 13, the data input/output buffer 14, and the bit line calculation circuit 15.

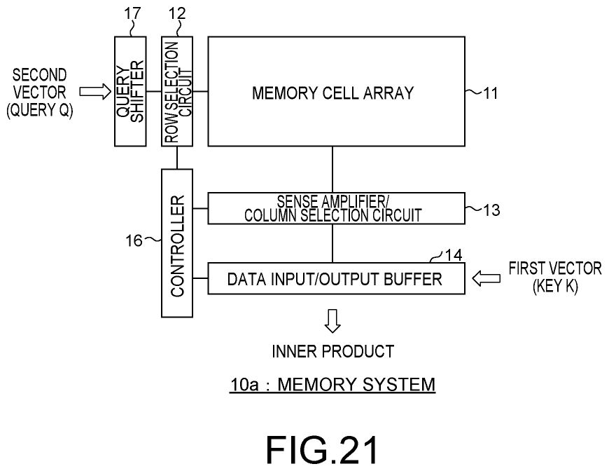

FIG. 21 is a block diagram illustrating a schematic configuration of a memory system 10a according to a modification of the third embodiment. The memory system 10a according to the modification includes a memory cell array 11, a row selection circuit 12, a sense amplifier/column selection circuit 13, a data input/output buffer 14, a controller 16 and a query shifter 17 as shown in FIG. 21.

The memory cell array 11 includes first and the second calculators 2a, 2b, a bit line BL, and a word line pair WL+, WL− including a first word line WL+ and a second word line WL− like the configuration shown in FIG. 13. The bit line BL carries a current corresponding to a multiplication value of integer elements. Therefore, the bit line calculation circuit 15 shown in FIG. 20 is not needed.

The query shifter 17 corrects the value of the query Q based on a first corrected multiplication value or a second corrected multiplication value. As a result, it is possible to cause the row selection circuit 12 to output a gate voltage corresponding to the corrected value of the query Q outputted from the query shifter 17, thereby causing a current corresponding to the first corrected multiplication value or the second corrected multiplication value to flow through the string 3 and the bit line BL.

As described above, in the third embodiment, the information processing apparatus 5 according to the first and second embodiments may be incorporated into the memory systems 10, 10a. It is thus possible to use an existing memory system to calculate the inner product of the first vector and the second vector.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus configured to perform a multiplication of a first integer element and a second integer element, the information processing apparatus comprising:
a first positive wiring line configured to carry a current corresponding to a multiplication value of the first integer element and the second integer element when the multiplication value is equal to or more than zero;
a first negative wiring line configured to carry a current corresponding to the multiplication value when the multiplication value is equal to or less than zero;
a second positive wiring line configured to be activated when the second integer element has a positive value;
a second negative wiring line configured to be activated when the second integer element has a negative value;
a first calculator connected to the first positive wiring line and the second positive wiring line to perform the multiplication of the first integer element and the second integer element and cause the current to flow through the first positive wiring line when the multiplication value is equal to or more than zero;
a second calculator connected to the first negative wiring line and the second positive wiring line to perform the multiplication of the first integer element and the second integer element and cause the current to flow through the first negative wiring line when the multiplication value is equal to or less than zero;
a third calculator connected to the first positive wiring line and the second negative wiring line to perform the multiplication of the first integer element and the second integer element and cause the current to flow through the first positive wiring line when the multiplication value is equal to or more than zero; and
a fourth calculator connected to the first negative wiring line and the second negative wiring line to perform the multiplication of the first integer element and the second integer element and cause the current to flow through the first negative wiring line when the multiplication value is equal to or less than zero, wherein
a direction of the current flowing through the first positive wiring line being the same as a direction of the current flowing through the first negative wiring line,
the first integer element is a positive integer, a negative integer, or zero, and
the second integer element is a positive integer, a negative integer, or zero.

2. The information processing apparatus according to claim 1, wherein, depending on whether the first integer element is equal to or more than zero or not and whether the second integer element is equal to or more than zero or not, the current corresponding to the multiplication value calculated by one of the first calculator, the second calculator, the third calculator, and the fourth calculator flows through the first positive wiring line or the first negative wiring line.

3. The information processing apparatus according to claim 2,
wherein when the first integer element is equal to or more than zero and the second integer element is equal to or more than zero, the current corresponding to the multiplication value calculated by the first calculator flows through the first positive wiring line and the multiplication values calculated by the second calculator, the third calculator, and the fourth calculator are zero,
wherein when the first integer element is equal to or less than zero and the second integer element is equal to or more than zero, the current corresponding to the multiplication value calculated by the second calculator flows through the first negative wiring line and the multiplication values calculated by the first calculator, the third calculator, and the fourth calculator are zero,
wherein when the first integer element is equal to or less than zero and the second integer element is equal to or less than zero, the current corresponding to the multiplication value calculated by the third calculator flows through the first positive wiring line and the multiplication values calculated by the first calculator, the second calculator, and the fourth calculator are zero, and
wherein when the first integer element is equal to or more than zero and the second integer element is equal to or less than zero, the current corresponding to the multiplication value calculated by the fourth calculator flows through the first negative wiring line and the multiplication values calculated by the first calculator, the second calculator, and the third calculator are zero.

4. The information processing apparatus according to claim 1, further comprising a plurality of calculator groups each including the first calculator, the second calculator, the third calculator, and the fourth calculator,
wherein each of the calculator groups calculates the multiplication value of the first integer element and the second integer element, the first integer element being one of a plurality of first integer elements of a first vector and the second integer element being one of a plurality of second integer elements of a second vector.

5. The information processing apparatus according to claim 4,
wherein each of the calculator groups is connected to the first positive wiring line and the first negative wiring line,
wherein the first positive wiring line carries a current corresponding to a sum of positive multiplication values calculated by the calculator groups, and
wherein the first negative wiring line carries a current corresponding to a sum of negative multiplication values calculated by the calculator groups.

6. The information processing apparatus according to claim 4, comprising a plurality of first wiring line groups arranged in a first direction and extending in a second direction that crosses the first direction,
wherein the first wiring line groups include a plurality of first wiring pairs each including the first positive wiring line and the first negative wiring line,
wherein the second positive wiring line and the second negative wiring line are disposed to cross the first wiring line groups, and
wherein the calculator groups are disposed at intersections of the second positive and second negative wiring lines and the first wiring line groups.

7. The information processing apparatus according to claim 1, wherein each of the first calculator, the second calculator, the third calculator, and the fourth calculator includes a transistor that carries a current corresponding to the multiplication value.

8. The information processing apparatus according to claim 7, wherein when the multiplication value of the first integer element and the second integer element is equal to or more than zero, the transistor carries the current corresponding to the multiplication value from the first positive wiring line or the first negative wiring line.

9. The information processing apparatus according to claim 7,
wherein a threshold voltage corresponding to the first integer element is set at the transistor, and
wherein a voltage corresponding to the second integer element is applied to the gate of the transistor via the second positive wiring line or the second negative wiring line.

10. The information processing apparatus according to claim 7,
wherein each of the first calculator, the second calculator, the third calculator, and the fourth calculator includes a string, one end of which being connected to the first positive wiring line or the first negative wiring line, and
wherein the string is a series of transistors including the transistor.

11. An information processing apparatus configured to perform a multiplication of a first integer element and a second integer element, the information processing apparatus comprising:
a first wiring line configured to carry a current corresponding to a multiplication value of the first integer element and the second integer element;
a second positive wiring line configured to be activated when the second integer element has a positive value;
a second negative wiring line configured to be activated when the second integer element has a negative value;
a first calculator connected to the first wiring line and the second positive wiring line and configured to cause a current corresponding to a first corrected multiplication value to flow through the first wiring line, the first corrected multiplication value being obtained by correcting the multiplication value of the first integer element and the second integer element so as to be equal to or more than zero; and
a second calculator connected to the first wiring line and the second negative wiring line and configured to cause a current corresponding to a second corrected multiplication value to flow through the first wiring line, the second corrected multiplication value being obtained by correcting the multiplication value of the first integer element and the second integer element so as to be equal to or more than zero, wherein
the first integer element is a positive integer, a negative integer, or zero, and
the second integer element is a positive integer, a negative integer, or zero.

12. The information processing apparatus according to claim 11, wherein the first calculator and the second calculator generate the first corrected multiplication value and the second corrected multiplication value by adding to the multiplication value of the first integer element and the second integer element a value that is equal to or more than a maximum value of absolute values of negative values among multiplication values of arbitrary combinations of all possible values of the first integer element and all possible values of the second integer element.

13. The information processing apparatus according to claim 11, wherein the first calculator and the second calculator generate the first corrected multiplication value and the second corrected multiplication value by adding to the multiplication value of the first integer element and the second integer element a value that is equal to or more than a maximum value of absolute values of negative values among multiplication values obtained from arbitrary combinations of all possible values of the first integer element and the second integer element.

14. The information processing apparatus according to claim 11, further comprising a plurality of calculator groups each including the first calculator and the second calculator,
wherein each of the calculator groups calculates the multiplication value of the first integer element and the second integer element, the first integer element being one of a plurality of first integer elements of a first vector and the second integer element being one of a plurality of second integer elements of a second vector.

15. The information processing apparatus according to claim 14,
wherein each of the calculator groups is connected to the first wiring line,
wherein the second positive wiring line and the second negative wiring line connected to each of the calculator groups are different, and
wherein the first wiring line carries a current corresponding to a sum of the first corrected multiplication value calculated by the first calculator and the second corrected multiplication value calculated by the second calculator.

16. The information processing apparatus according to claim 14, comprising a plurality of first wiring lines arranged in a first direction and extending in a second direction crossing the first direction,
wherein the second positive wiring line and the second negative wiring line are arranged to cross the plurality of first wiring lines, and
wherein the calculator groups are disposed at intersections of the second positive and second negative wirings line and the plurality of first wiring lines.

17. The information processing apparatus according to claim 11, wherein each of the first calculator and the second calculator includes a transistor that carries a current corresponding to the multiplication value.

18. The information processing apparatus according to claim 17, wherein the transistor causes the current corresponding to the first corrected multiplication value or the second corrected multiplication value to flow from the first wiring line.

19. A memory system configured to calculate an inner product of a first vector including a plurality of integer elements and a second vector including a plurality of integer elements, the memory system comprising:
a first positive wiring line configured to carry a current corresponding to a multiplication value of an integer element of the first vector and an integer element of the second vector corresponding to the integer element of the first vector when the multiplication value is equal to or more than zero;
a first negative wiring line configured to carry a current corresponding to the multiplication value of the integer element of the first vector and the integer element of the second vector corresponding to the integer element of the first vector when the multiplication value is equal to or less than zero;
a second positive wiring line configured to be activated when the integer element of the first vector has a positive value;
a second negative wiring line configured to be activated when the integer element of the first vector has a negative value;
a first calculator connected to the first positive wiring line and the second positive wiring line and configured to cause a current to flow through the first positive wiring line when the multiplication value of the integer element of the first vector and the integer element of the second vector corresponding to the integer element of the first vector is equal to or more than zero;
a second calculator connected to the first negative wiring line and the second positive wiring line and configured to cause a current to flow through the first negative wiring line when the multiplication value of the integer element of the first vector and the integer element of the second vector corresponding to the integer element of the first vector is equal to or less than zero;
a third calculator connected to the first positive wiring line and the second negative wiring line and configured to cause a current to flow through the first positive wiring line when the multiplication value of the integer element of the first vector and the integer element of the second vector corresponding to the integer element of the first vector is equal to or more than zero;
a fourth calculator connected to the first negative wiring line and the second negative wiring line and configured to cause a current to flow through the first negative wiring line when the multiplication value of the integer element of the first vector and the integer element of the second vector corresponding to the integer element of the first vector is equal to or less than zero; and
a fifth calculator configured to make a calculation relating to voltages or currents of the first positive wiring line and the first negative wiring line.

20. A memory system configured to calculate an inner product of a first vector including a plurality of first integer elements and a second vector including a plurality of second integer elements, the memory system comprising:
a first wiring line configured to carry a current corresponding to a multiplication value of a first integer element of the first vector and a second integer element of the second vector corresponding to the first integer element of the first vector;
a second positive wiring line configured to be activated when the second integer element of the second vector has a positive value;
a second negative wiring line configured to be activated when the second integer element of the second vector has a negative value;
a first calculator connected to the first wiring line and the second positive wiring line and configured to cause a current corresponding to a first corrected multiplication value to flow through the first wiring line, the first corrected multiplication value being obtained by correcting the multiplication value of the first integer element of the first vector and the corresponding second integer element of the second vector so as to be equal to or more than zero;
a second calculator connected to the first wiring line and the second negative wiring line and configured to cause a current corresponding to a second corrected multiplication value to flow through the first wiring line, the second corrected multiplication value being obtained by correcting the multiplication value of the first integer of the first vector element and the corresponding second integer element of the second vector so as to be equal to or more than zero; and
a wiring voltage corrector configured to correct a voltage according to a corresponding second integer element of the second vector based on the first corrected multiplication value and the second corrected multiplication value,
wherein the first calculator causes the current corresponding to the first corrected multiplication value to flow through the first wiring line using the voltage corrected by the wiring voltage corrector,
the second calculator causes the current corresponding to the second corrected multiplication value to flow through the first wiring line using the voltage corrected by the wiring voltage corrector.
